(19) United States
(12) Patent Application Publication
(10) Pub. No.: US 2025/0002022 A1
(43) Pub. Date: Jan. 2, 2025

(54) EMERGENT RESPONSE COMMUNICATIONS FOR VEHICLE COMPANION

(71) Applicant: FCA US LLC, Auburn Hills, MI (US)

(72) Inventor: Anand Sunadham, Farmington Hills, MI (US)

(21) Appl. No.: 18/341,915

(22) Filed: Jun. 27, 2023

(51) Int. Cl. B60W 40/08; G07C 5/00

(52) U.S. Cl. CPC B60W 40/08; G07C 5/008; B60W 2040/0809

(57) ABSTRACT

A system and method for automatically engaging a vehicle user with a mobile device user. The method includes: receiving a mobile device user input from a mobile device user, wherein the mobile device user input indicates a presence of an emergent situation; transmitting a vehicle-mobile device connect message to a vehicle mobile application, wherein the vehicle mobile application is a mobile application for engaging with a vehicle of the vehicle user; and in response to receiving the vehicle-mobile device connect message at the vehicle mobile application, establishing direct communications between a vehicle user device executing the vehicle mobile application and a mobile device at which the mobile device user input is provided by the mobile device user.

### FIELD

The present disclosure relates to providing a user application that enables a user to be directly connected to a vehicle user for communications responsive to an emergent event or situation.

### BACKGROUND

Cellular devices, such as smartphones, are widely used for communications between individuals who are not co-located, such as between family members during a weekday when the members are often at work or school. Generally, a user may initiate a call by dialing a phone number of another user. However, there is a need to more readily and quickly establish communications between individuals, such as family members and/or other familial-like individuals that are close companions to one another.

### SUMMARY

In at least some implementations, a method of automatically engaging a vehicle user with a mobile device user is provided. The method includes: receiving a mobile device user input from the mobile device user, wherein the mobile device user input indicates a presence of an emergent situation; transmitting a vehicle-mobile device connect message to a vehicle mobile application, wherein the vehicle mobile application is a mobile application for engaging with a vehicle of the vehicle user; and in response to receiving the vehicle-mobile device connect message at the vehicle mobile application, establishing direct communications between a vehicle user device executing the vehicle mobile application and a mobile device at which the mobile device user input is provided by the mobile device user.

In at least some implementations, an emergent response communications system is provided. The emergent response communications system includes: (i) a vehicle mobile application for engaging with a vehicle of a vehicle user, the vehicle mobile application being implemented through vehicle mobile application computer instructions that are executable by one or more processors of a vehicle user device of the vehicle user; (ii) a companion mobile application for communicating an indication of an emergent situation to the vehicle mobile application, the companion mobile application being implemented through companion mobile application computer instructions that are executable by one or more processors of a mobile device of a mobile device user; and (iii) a backend application computer system configured to receive the indication of the emergent situation from the companion mobile application and to transmit a vehicle-mobile device connect message to the vehicle mobile application. The vehicle mobile application is configured to: in response to receiving the vehicle-mobile device connect message at the vehicle mobile application, establish direct communications between the vehicle user device and the mobile device.

In at least some implementations, an emergent response communications system is provided. The emergent response communications system includes: (i) a primary vehicle management application for engaging with a vehicle, the primary vehicle management application being implemented through primary vehicle management application computer instructions that are executable by one or more processors of a vehicle user device; (ii) a companion mobile application for communicating an indication of an emergent situation to the primary vehicle management application, the companion mobile application being implemented through companion mobile application computer instructions that are executable by one or more processors of a mobile device of a mobile device user; and (iii) a backend application computer system. The backend application computer system is configured to: (a) receive the indication of the emergent situation from the companion mobile application; (b) identify a vehicle user based on prestored information that indicates the vehicle user is associated with the mobile device user prior to the indication of the emergent situation being received at the backend application computer system, and (c) transmit a vehicle-mobile device connect message to the primary vehicle management application used by the vehicle user that is identified based on the mobile device user. The primary vehicle management application is configured to: in response to receiving the vehicle-mobile device connect message at the primary vehicle management application, establish direct communications between the vehicle user device and the mobile device.

Further areas of applicability of the present disclosure will become apparent from the detailed description, claims, and drawings provided hereinafter. It should be understood that the summary and detailed description, including the disclosed embodiments and drawings, are merely exemplary in nature intended for purposes of illustration only and are not intended to limit the scope of the invention, its application, or use. Thus, variations that do not depart from the gist of the disclosure are intended to be within the scope of the invention.

### BRIEF DESCRIPTION OF THE DRAWINGS

FIG. 1 is a diagrammatic illustration of a communications system having a mobile device, a vehicle, and a backend computer system that are used to implement an emergent response communications system, according to one embodiment;

FIG. 2 is a flowchart illustrating an embodiment of a method of automatically engaging a vehicle user with a mobile device user, according to one embodiment; and

FIG. 3 is a diagrammatic illustration of a communications system having three mobile or companion devices, a vehicle having a vehicle user device, and a backend computer system that are used to implement an emergent response communications system, according to one embodiment.

### DETAILED DESCRIPTION

Referring in more detail to the drawings, there is provided a system and method for automatically engaging a vehicle user with a mobile device user, such as for purposes of connecting the mobile device user to the vehicle user in response to an emergent situation. In embodiments, there is provided an emergent response communications system that includes a vehicle mobile application for engaging with a vehicle of the vehicle user; a companion mobile application for communicating an indication of an emergent situation to the vehicle mobile application; and a backend application computer system configured to receive the indication of the emergent situation from the companion mobile application and to transmit a vehicle-mobile device connect message to the vehicle mobile application so as to effectuate the vehicle mobile application establishing direct communications between a vehicle user device executing the vehicle mobile application and a mobile device executing the companion mobile application.

According to embodiments, there is provided a method of automatically engaging a vehicle user with a mobile device user, and this method includes: receiving a mobile device user input from a mobile device user, the mobile device user input indicating a presence of an emergent situation; transmitting a vehicle-mobile device connect message to a vehicle mobile application, the vehicle mobile application being a mobile application for engaging with a vehicle of the vehicle user; and in response to receiving the vehicle-mobile device connect message at the vehicle mobile application, establishing direct communications between a vehicle user device executing the vehicle mobile application and a mobile device at which the mobile device user input is provided by the mobile device user.

According to embodiments, the vehicle user is a connected services subscriber that is provided with a primary vehicle management application to manage their vehicle, and a companion mobile application is provided to family members of the vehicle owner. For example, at a given time, the family member may be at school, a mall, or a playground. In the event of an emergency situation, the family member (e.g., child) could use the companion mobile application to immediately get connected to their parents. The companion mobile application provides the location and opens the camera and microphone of the mobile device for communication with the vehicle user (e.g., parents) via a camera and/or a microphone of the vehicle user device. Thus, according to embodiments, there is no need for the family member to dial, but can be connected at the touch of a button (e.g., graphical pushbutton on a graphical user interface) on the companion mobile application.

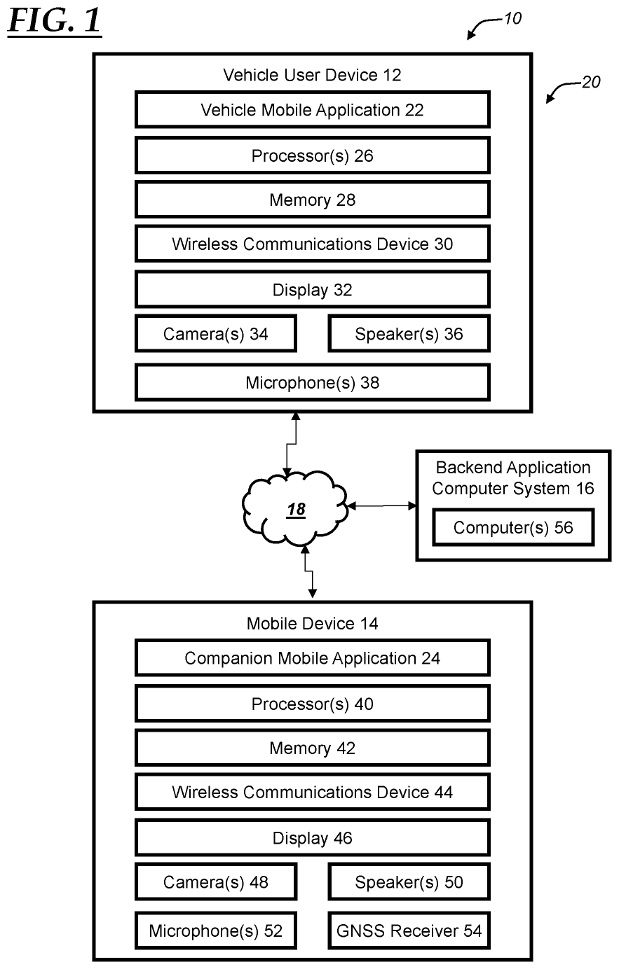

With reference to FIG. 1, there is provided a communications system 10 having a vehicle user device 12 for a vehicle, a mobile device 14, a backend application computer system 16, and a communications network 18. The communications system 10 also includes an emergent response communications system 20 that includes a vehicle mobile application 22 for engaging with the vehicle; a companion mobile application 24 for communicating an indication of an emergent situation to the vehicle mobile application 22; and a backend application computer system 16 configured to receive the indication of the emergent situation from the companion mobile application 24 and to transmit a vehicle-mobile device connect message to the vehicle mobile application 22, where the vehicle mobile application 22 is configured to: in response to receiving the vehicle-mobile device connect message at the vehicle mobile application, establish direct communications between the vehicle user device 12 and the mobile device 14.

The companion mobile application 24 is a mobile device application, which is a mobile application that is executed on the mobile device 14. Further, the companion mobile application 24 is a “companion” to the vehicle 22 mobile application and/or vehicle in that the companion mobile application 24 is for providing auxiliary services to authorized individuals including the mobile device user. And a companion mobile application is a “companion-only mobile application” when the companion mobile application does not actively engage with the vehicle. As used herein, “auxiliary services”, when used in connection with a mobile application acting as a companion for a vehicle, refers to one or more services that do not relate to the operation of the vehicle, such as establishing direct communication for a video call between individuals (e.g., the vehicle user and the mobile device user).

The communications network 18 is used for enabling communications between the vehicle user device 12, the mobile device 14, and the backend application computer system 16. The communications network 18 is shown as a single cloud icon in FIG. 1, as those skilled in the art will appreciate that any suitable data communications network may be used as the communications network 18, and this oftentimes involves use of cellular infrastructure and/or internet infrastructure. Here, “cellular infrastructure” refers to cell towers, mobile switching centers, carrier core networks, and other equipment and/or components used for carrying out cellular communications. And, here, “internet infrastructure” refers to one or more interconnected computer networks that use the Internet protocol (IP) suite (e.g., TCP/IP, UDP/IP) to communicate between networks and devices so as to facilitate data exchange. In embodiments, other infrastructures and/or any combination thereof may be used as well for the communications network 18.

The vehicle user device 12 is an electronic mobile device that is used to execute the vehicle mobile application 22, which is usable by the vehicle user for engaging with the vehicle, such as for controlling the vehicle and/or viewing information about the vehicle. As used herein, when an application is said to be “engaging with” a vehicle, this means that the application is usable to control the vehicle and/or view operation information for the vehicle. As used herein, “operation information” for a vehicle means any information relating to the operation of the vehicle, such as fuel level, location, ignition status, occupant status, and/or door sensor status, for example. In embodiments, the vehicle mobile application 22 is a primary vehicle management application, which is a mobile application that allows the vehicle user to actively engage with the vehicle. As used herein, “actively engaging with” a vehicle means “engaging with” the vehicle so as to control the vehicle and/or view live operation information for the vehicle. As used herein, “live operation information” means “operation information” that is updated within the last 24 hours, such as updating a fuel level based on a recent fuel level reading, for example.

The vehicle user device 12 includes one or more processors 26, memory 28, a wireless communications device 30, a display 32, one or more cameras 34, one or more speakers 36, and one or more microphones 38. The vehicle mobile application 22 is implemented through vehicle mobile application computer instructions that are executable by the processor(s) 26 and that are stored on the memory 28, which is accessible by the processor(s) 26.

The vehicle user device 12 is used to execute the vehicle mobile application 22, and is a mobile electronic device, such as a smartphone or an onboard vehicle computer system. In such embodiments where the vehicle mobile application 22 is an onboard vehicle computer system/device, the vehicle user device 12 is implemented through one or more components of the vehicle, such as those components 26-38. It will be appreciated that the vehicle user device 12 may include additional components, such as multiple displays, for example.

The mobile device 14 includes one or more processors 40, memory 42, a wireless communications device 44, a display 46, one or more cameras 48, one or more speakers 50, one or more microphones 52, and a global navigation satellite system (GNSS) receiver 54. The companion mobile application 24 is implemented through vehicle mobile application computer instructions that are executable by the processor(s) 40 and that are stored on the memory 42, which is accessible by the processor(s) 40. It will be appreciated that the vehicle user device 12 may include additional components, such as multiple displays, for example.

The one or more processors 26,40 are each an electronic processor, and may be any suitable electronic processor, such as: x86/x86-64 processors, such as Intel™ Core series and AMD Ryzen™ series, widely adopted in the personal computing domain; or ARM processors, such as Qualcomm Snapdragon™, NVIDIA Tegra™, and Apple M1™ processors, common for mobile and embedded systems. It will be appreciated that these are examples, as other electronic processors may be used.

The memory 28,42 is a non-transitory, computer-readable memory that is implemented as a non-volatile computer data storage device, such as, for example, ROM (read-only memory), solid-state drives (SSDs) (including other solid-state storage such as solid-state hybrid drives (SSHDs)), other types of flash memory, hard disk drives (HDDs), magnetic or optical disc drives, non-volatile random access memory (NVRAM), etc.

The wireless communications device 30,44 is an electronic device that is used for carrying out wireless communications, such as cellular carrier communications (or other long-range wireless communications) and/or dedicated short-range communications (DSRC) (e.g., Wi-Fi™, Bluetooth™) (or other short-range wireless communications). In embodiments, the wireless communications device 30,44 is implemented as a telematics unit and includes a cellular chipset used for cellular carrier communications, such as for communicating with an end point through use of cellular infrastructure. In other embodiments, the wireless communications device 30,44 includes DSRC circuitry, such as a Bluetooth™ chipset, for communications via DSRC technology. In some embodiments, one or both of the vehicle user device 12 and the mobile device 14 includes both short- and long-range communication capabilities and is implemented through one or more electronic devices of the vehicle user device 12.

The display 32,46 is an electronic display that is used for presenting information or images to the vehicle user. The display 32,46 is an electronic display that is used to present information, images, and/or other graphics to the user of an application (such as the vehicle user application 22 for the vehicle user device 12 and the companion mobile application 24 for the mobile device 14) and/or vehicle (the “vehicle user”), such as a graphical output provided by the vehicle user application 22 or the companion mobile application 24. The display 32,46 may be any of a variety of suitable electronic displays, such as, for example, Liquid Crystal Displays (LCD), Organic Light-Emitting Diode (OLED) displays, or Quantum Dot Displays (QLED).

The one or more camera(s) 34,48 are each used to obtain image data of one or more objects within the environment, and each may be any suitable digital camera, such as those employing Complementary Metal-Oxide-Semiconductor (CMOS) sensors, for example; however, it will be appreciated that other types of image sensors may be employed for the camera(s) 34,48.

The one or more speaker(s) 36,50 are each used to transmit audio data, such as call audio, within the environment, and each may be any suitable digital speaker, such as those employing dynamic (moving coil), planar magnetic, electrostatic, or balanced armature driver types, for example; however, it will be appreciated that other types of audio transducers may be employed for the speaker(s) 36,50.

The one or more microphone(s) 38,52 are each used to capture audio data, such as voice audio, within the environment, and each may be any suitable digital microphone, such as those employing MEMS (Micro-Electro-Mechanical Systems), electret condenser, or omnidirectional designs, for example; however, it will be appreciated that other types of audio sensors suitable for a smartphone or vehicle environment may be employed for the microphone(s) 38,52.

The GNSS receiver 54 of the mobile device 14 is used to provide a geographic location of the mobile device 14, such as a geographic coordinate location specifying at least a latitudinal coordinate and a longitudinal coordinate. The geographic location may be stored in the memory 42 of the mobile device 14 and/or sent to the vehicle user device 12. In one embodiment, the location of the mobile device 14 is sent to the vehicle user device 12 when the mobile device user provides the mobile device user input. In the United States of America, the GNSS receiver 54 may be a global positioning system (GPS) receiver. In other embodiments, the mobile device 14 includes a different location determining mechanism, such as, for example, cellular triangulation that uses data from multiple cell towers to locate a device with relative accuracy or Wi-Fi™ positioning, which utilizes the signal strengths of nearby Wi-Fi™ networks to approximate a device's location.

The backend application computer system 16 includes one or more computers 56, each of which has a processor and memory storing computer instructions, where the computer 56 is configured to use the processor to execute the computer instructions. The backend application computer system 16 may be a centralized or distributed computer system, and may be implemented via cloud computing and/or through use of distributed computer instances, some of which may be deemed “virtual” but all of which rely and are executed on an underlying computer or set of computers. The backend application computer system 16 also includes appropriate communications device(s) for carrying out communications with the communications network 18.

In embodiments, the backend application computer system 16 is managed, operated, and/or otherwise provided by an original equipment manufacturer (OEM) of the vehicle. For example, in some embodiments, the backend application computer system 16 corresponds to a backend computer system that is provided by the OEM and that is used for engaging with a large number of vehicles manufactured by the OEM. The OEM backend application computer system is in a unique position to leverage vehicle resources, including the vehicle mobile application 22, which, in embodiments, is provided by the OEM as well as an OEM mobile application. Also, at least in some embodiments, the vehicle mobile application 22 is a primary vehicle management application, which is a mobile application that is usable to actively engage with the vehicle. Likewise, in embodiments, the companion mobile application 24 is an OEM mobile application and, more particularly, a companion OEM mobile application.

The backend application computer system 16 is configured to provide services to the vehicle mobile application 22 and the companion mobile application 24 so as to support each's respective features. More particularly, the backend application computer system 16 acts to coordinate operation between vehicle user devices, such as the vehicle user device 12, and companion mobile devices, such as the mobile device 14.

The backend application computer system 16 is, at least in embodiments, an amalgamation of a variety of software and hardware components, implemented by a backend application party and/or one or more backend application party service providers, such as those that provide cloud services for data storage, security, etc. Nonetheless, in such embodiments, the backend application computer system 16 is a computer system with its various components coordinated to provide a backend for the vehicle user application 22 as well as the companion mobile application 24. In this regard, at least one of the one or more computers 56 of the backend application computer system 16 constitutes a backend server for the vehicle mobile application 22 and the companion mobile application 24, at least in embodiments.

In embodiments, the vehicle to which the vehicle user device 12 corresponds is one vehicle of a set of vehicles, where each vehicle in the set of vehicles is associated with a vehicle user. The vehicle user is issued credentials for a vehicle mobile application 22, such as a primary vehicle management application, enabling active engagement of the vehicle via the vehicle mobile application 22. In such embodiments, one or more vehicle user companions (or simply “companions”) are defined and are issued credentials for using the companion mobile application 24 in conjunction with the vehicle mobile application 22 (e.g., the primary vehicle management application).

In embodiments, a vehicle account for the vehicle user is held and maintained through the backed application computer system 16, which may include use of various third-party services. In embodiments, the set of vehicles is a plurality of vehicles manufactured by an automotive OEM, where the OEM, through its backend application computer system 16, keeps track of vehicle users, vehicle user accounts for the vehicle users, and the companions of the vehicle user. This data associating a vehicle user (or vehicle device user) with one or more companions is referred to as vehicle user companion data. The vehicle user companion data is used to identify a vehicle user device 12 based on a companion, at least in embodiments, and may be modified in response to data received from the vehicle mobile application 22; for example, the vehicle device user uses a graphical user interface (GUI) of the vehicle mobile application 22 to enter a companion identifier, which identifies a companion user account associated with a companion. In another embodiment, a unique identifier, such as a telephone number, is used by the vehicle device user in order to specify which companions or companion mobile applications 24 are authorized for use with the corresponding vehicle mobile application 22.

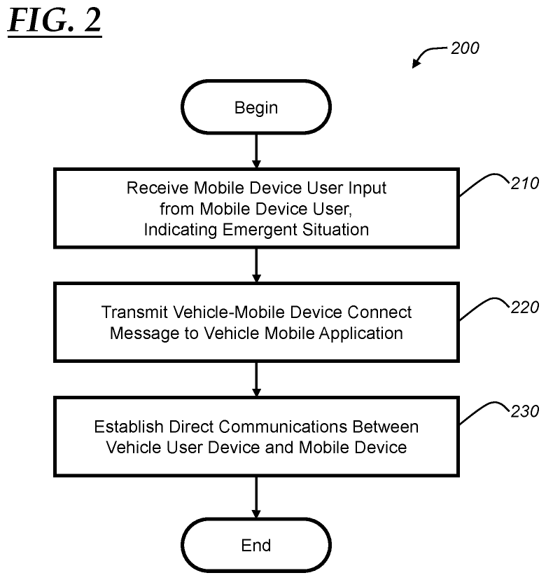

With reference to FIG. 2, there is shown a method 200 of automatically engaging a vehicle user with a mobile device user. The method 200 is carried out by the emergent response communications system 20, at least in some embodiments, as discussed below.

The method 200 begins with step 210, wherein a mobile device user input is received from a mobile device user, where the mobile device user input indicates a presence of an emergent situation. As used herein, a presence of an emergent situation refers to a sudden, unexpected circumstance or event that necessitates immediate action or response due to its potential to cause significant harm or disruption. The mobile device user input is provided by the mobile device user through the mobile device user using a companion mobile application, such as the companion mobile application 24, at least in embodiments.

For example, in one embodiment, the companion mobile application 24 includes a graphical user interface (GUI) having a graphical button that is displayed on a touchscreen of the mobile device (e.g., smartphone), and the mobile device user input is provided by the mobile device user touching or clicking on the button. In another embodiment, a voice command is used to provide the mobile device user input; for example, the companion mobile application 24 may be responsive to voice-activated inputs by a user, such as those used with a wake word, and the mobile device user input is realized through processing by the companion mobile application 24 in response to such voice-activated inputs. The mobile device user input is then sent by the companion mobile application 24 from the mobile device 14 to the backend application computer system 16, which then receives the mobile device user input. The communications network 18 is used to transmit a message (or messages) containing the mobile device user input from the mobile device 14 to the backend application computer system 16. The method 200 continues to step 220.

In step 220, a vehicle-mobile device connect message is transmitted to a vehicle mobile application. The vehicle mobile application is a mobile application for engaging with a vehicle of the vehicle user. For example, the vehicle mobile application 22 is installed on the vehicle user device 12, which is used by the vehicle user for interacting with the vehicle mobile application 22. The vehicle-mobile device connect message is used to cause the vehicle mobile application 22 to initiate establishment of direct communications between the vehicle user device 12 and the mobile device 14.

In embodiments, the vehicle-mobile device connect message is a simple messaging service (SMS) or push notification that is sent to a cellular device, such as the vehicle user device 12 where the wireless communications device 30 includes a cellular chipset or other hardware enabling cellular telephony over cellular infrastructure. In such an embodiment, for example, a third-party messaging service may be used, such as Twilio™ and/or Firebase™ for purposes of providing an environment configured to automatically identify the vehicle user device 12 to which the vehicle-mobile device connect message is to be sent. As one such example, an SMS or push notification is transmitted to a cellular device using the following exemplary process: A server of the backend application computer system 16 first integrates with a third-party messaging service, such as those offered by Twilio™ or Firebase™ and, when a user installs the mobile application (the vehicle mobile application 22, for example), their device (the vehicle user device 12, for example) is registered with the service, and is issued a unique identifier that is stored on the server. The server of the backend application computer system 16 sends the vehicle-mobile device connect message via an HTTP request to the third-party messaging service's application programming interface (API), which (based on the received request which includes the unique device identifier and the message payload), the third-party service then delivers the vehicle-mobile device connect message to the device where the vehicle-mobile device connect message appears as an SMS or a push notification, depending on the type of message sent.

Also, as mentioned above, in embodiments, the vehicle user device 12 is onboard the vehicle and portions thereof may correspond to an infotainment unit, for example. In such embodiments, a third-party messaging service is not used, rather, a direct SMS or push notification messaging approach may be used. For example, to initiate a direct SMS from a server, a Short Message Service Center (SMSC) is used to lease a short code or long code (phone number). An SMS payload for the vehicle-mobile device connect message is constructed and dispatched via Short Message Peer-to-Peer (SMPP) protocol to the SMSC, specifying recipient's number and message content. The SMSC then bridges with the recipient's cellular network to route the SMS to the end device, which is the vehicle user device 12 in the present embodiment. The method 200 continues to step 230.

In step 230, direct communications are established between a vehicle user device executing the vehicle mobile application and a mobile device at which the mobile device user input is provided by the mobile device user, and the direct communications are established in response to receiving the vehicle-mobile device connect message at the vehicle mobile application. As used herein, “direct communications”, when used in connection with being established between two endpoint devices, means a dedicated channel (or a virtual dedicated channel in the case of Wi-Fi™ calls where VoIP packets are prioritized using Quality of Service (QOS) configurations, for example) is used for voice, text, and/or audio communications between the two endpoint devices, such as that which is established as a part of a cellular telephone call between two endpoint devices. In embodiments, the vehicle user device 12 establishes direct communications with the mobile device 14 through use of a cellular telephone call that is placed between the vehicle user device 12 (as a first cellular, endpoint device) and the mobile device 14 (as a second cellular, endpoint device); for example, in response to receiving the vehicle-mobile device connect message, the vehicle mobile application 22 initiates a telephone call using the wireless communications device 30, which may be a telematics unit or other unit with a cellular chipset. In embodiments, a video call, such as FaceTime™, which may use Voice over Internet Protocol (VoIP) or other similar streaming data over IP protocols, may be used as the direct communications between the vehicle user device 12 and the mobile device 14. In embodiments, the location of the mobile device 14, such as one determined using the GNSS receiver 54, is sent to the vehicle user device 12 so that the vehicle user is informed of the companion's location. The method 200 ends.

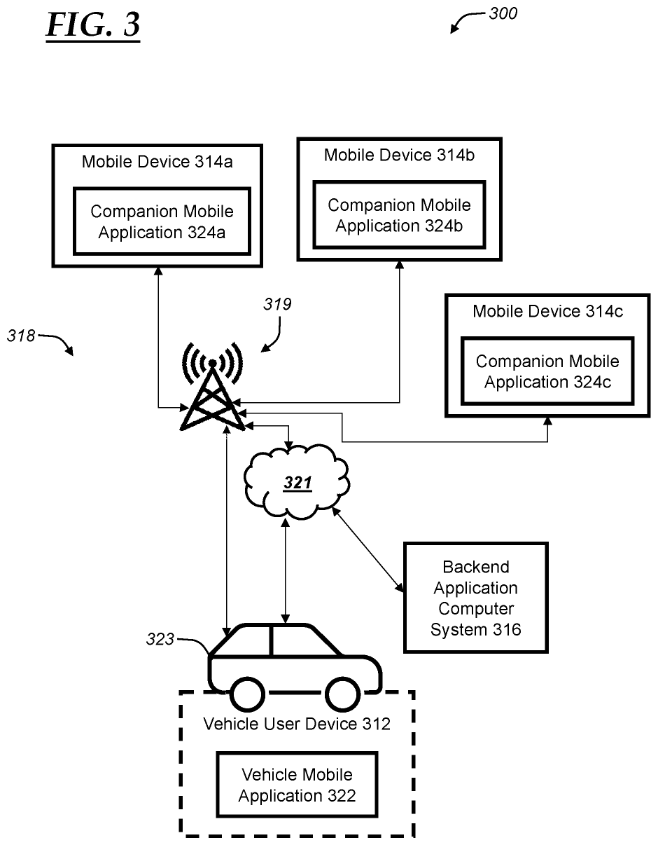

With reference to FIG. 3, there is shown an exemplary communications system 300 that includes a vehicle user device 312 for a vehicle, a plurality of mobile devices 314a-c, a backend application computer system 316, and a communications network 318 comprised of a cellular network 319 and an interconnected data network (e.g., internet) 321. The vehicle user device 312 is installed as a part of a vehicle 323 in the present embodiment and includes a vehicle mobile application 322. Components of FIG. 3 are analogous to like components of FIG. 1 that have the same least significant two digits (e.g., “12” for “12” and “312”); the above discussion of those like components is hereby incorporated and attributed to its corresponding component of FIG. 3, and is not expressly repeated here for brevity. Furthermore, each mobile device 314a-c is analogous to the mobile device 14 and that discussion is hereby incorporated and attributed to each mobile device 314a-c to the extent such discussion is not inconsistent with the express discussion of each mobile device 314a-c below.

The cellular network 319 is implemented using cellular infrastructure, including, for example, Base Transceiver Stations (BTS), Base Station Controllers (BSC), Mobile Switching Center (MSC), Public Switched Telephone Network (PSTN), Home Location Register (HLR), Visitor Location Register (VLR), Authentication Center (AuC), and data service managers like Gateway GPRS Support Node (GGSN) and Serving GPRS Support Node (SGSN). However, it will be appreciated that the components forming the cellular infrastructure can vary based on factors such as the network generation (e.g., 2G, 3G, 4G, 5G), the specific technology (e.g., GSM, CDMA, LTE), and the particular implementation by a network owner or operator. For instance, 4G LTE networks incorporate evolved components such as the Evolved NodeB and the Evolved Packet Core with its Mobility Management Entity, Serving Gateway, and Packet Data Network Gateway. And, for instance, 5G architecture introduces new elements including the gNodeB and the 5G Core with components like the Access and Mobility Management Function and Session Management Function. The implementation of the cellular network may also differ based on network size, with smaller networks potentially combining functions for efficiency, while larger networks may add components for increased scalability and functionality.

The interconnected data network 321 is an Internet Protocol (IP) based network that comprises various elements based on its scale, purpose, and the specific protocols employed. Fundamental components include end-user devices (like computers and mobile devices), routers and switches to forward data packets, and servers to host applications and data. Network Interface Cards (NICs) in each device provide the hardware interface for network connectivity. IP networks employ a suite of protocols, notably TCP/IP for data transmission, where the IP part handles packet routing, while TCP ensures data integrity. Moreover, DNS servers are utilized to resolve human-readable domain names into IP addresses. For security, firewalls are used to monitor and control incoming and outgoing network traffic based on predetermined security rules. Depending on the network's complexity, additional components like load balancers, proxy servers, and Virtual Private Network (VPN) gateways may be incorporated. The exact configuration and component selection vary based on specific network requirements and design choices.

Each mobile device 314a-c is a mobile that is capable of long-range communications, such as those carried out over the cellular network 319 and/or the interconnected data network 321. In embodiments, each of the mobile devices 314a-c is a cellular device or user equipment, such as a smartphone. In other embodiments, one or more of the mobile devices 314a-c are not cellular devices, but rather have a wireless communications device that connects to an interconnected data network, such as the interconnected data network 321. In the illustrated embodiment, the mobile devices 314a-c are each shown as being communicatively coupled to the cellular network 319; however, it will be appreciated that, according to embodiments, the mobile devices 314a-c each are communicatively coupled, such as by virtue of a Wi-Fi™ device, to the interconnected data network 321.

The mobile devices 314a-c each includes a companion mobile application 324a-c that acts as a companion to the vehicle mobile application 322 and/or the vehicle 323. Each companion mobile application 324a-c is analogous to the companion mobile application 24 and that discussion is hereby incorporated and attributed to each companion mobile application 324a-c to the extent such discussion is not inconsistent with the express discussion of each companion mobile application 324a-c below.

According to embodiments, each of the companion mobile applications 324a-c is usable by a user to provide the mobile device user input, which is then sent to the backend application computer system 316, whereat a vehicle user device 312 is identified. The backend application computer system 316 then sends a vehicle-mobile device connect message to the identified vehicle user device 312. The vehicle user device 312 may then initiate a direct communication connection with the respective companion mobile device 314a-c that issued the mobile device user input. The direct communication may be implemented using built-in phone software of a smartphone, and this built-in software may be invoked by the vehicle mobile application 322 in response to the vehicle-mobile device connect message.

For example, in one embodiment, a first companion mobile application 324a sends the mobile device user input to the backend application computer system 316. Then, the backend application computer system 316 determines which vehicle user device (from a plurality thereof) is the appropriate vehicle user device, which is determined based on which vehicle user device (here, the vehicle user device 312) is associated with the companion mobile application 324a having provided the mobile device user input.

Thus, according to embodiments, the vehicle user (e.g., a parent) is provided with full communication with the companion (e.g., a family member) and is also provided with their location. The parents may advise their family members on the actions to take, drive to the location of their companion, take help of the local police, or take some other action, for example.

What is claimed is:

1. A method of automatically engaging a vehicle user with a mobile device user, comprising:
receiving a mobile device user input from a mobile device user, wherein the mobile device user input indicates a presence of an emergent situation;
transmitting a vehicle-mobile device connect message to a vehicle mobile application, wherein the vehicle mobile application is a mobile application for engaging with a vehicle of a vehicle user; and
in response to receiving the vehicle-mobile device connect message at the vehicle mobile application, establishing direct communications between a vehicle user device executing the vehicle mobile application and a mobile device at which the mobile device user input is provided by the mobile device user.

2. The method of claim 1, further comprising a step of identifying the vehicle user based on the mobile device user, wherein the vehicle user is pre-associated with the mobile device user prior to receiving the mobile device user input.

3. The method of claim 2, wherein the mobile device user is authorized to operate the mobile device application for providing mobile device user inputs including the mobile device user input.

4. The method of claim 1, wherein the direct communications between the vehicle user device and the mobile device include audio and/or video communications so that the vehicle user and the mobile device user are able to communicate audibly and/or visually.

5. The method of claim 1, wherein the vehicle mobile application is usable by the vehicle user for determining a location of the mobile device user.

6. The method of claim 5, wherein the mobile device application identifies a location of the vehicle of the vehicle user in response to receiving the mobile device user input.

7. The method of claim 6, wherein the mobile device application is configured to display the location of the vehicle of the vehicle user only when the mobile device user provides the mobile device user input.

8. The method of claim 1, wherein the vehicle user device is an electronic device installed on the vehicle of the vehicle user.

9. The method of claim 1, wherein the vehicle user device is a handheld mobile device of the vehicle user.

10. The method of claim 1, wherein the vehicle mobile application is an original equipment manufacturer (OEM) mobile application that is provided by an OEM of the vehicle.

11. The method of claim 10, wherein the mobile device application is a companion OEM mobile application that is provided by the OEM of the vehicle and that is for providing auxiliary services to authorized individuals including the mobile device user.

12. The method of claim 11, wherein the vehicle mobile application is usable to provide the mobile device user with access to one or more features of the mobile device application including a feature that enables the mobile device user to provide the mobile device user input so as to cause the direct communications between the vehicle user device and the mobile device to be established.

13. An emergent response communications system, comprising:
a vehicle mobile application for engaging with a vehicle of a vehicle user, the vehicle mobile application being implemented through vehicle mobile application computer instructions that are executable by one or more processors of a vehicle user device of the vehicle user;
a companion mobile application for communicating an indication of an emergent situation to the vehicle mobile application, the companion mobile application being implemented through companion mobile application computer instructions that are executable by one or more processors of a mobile device of a mobile device user; and
a backend application computer system configured to receive the indication of the emergent situation from the companion mobile application and to transmit a vehicle-mobile device connect message to the vehicle mobile application;
wherein the vehicle mobile application is configured to: in response to receiving the vehicle-mobile device connect message at the vehicle mobile application, establish direct communications between the vehicle user device and the mobile device.

14. The emergent response communications system of claim 13, wherein the backend application computer system includes a vehicle user companion data store that stores data associating the mobile device user with the vehicle user.

15. The emergent response communications system of claim 14, wherein the direct communications between the vehicle user device and the mobile device include audio and/or video communications so that the vehicle user and the mobile device user are able to communicate audibly and/or visually.

16. The emergent response communications system of claim 13, wherein the vehicle mobile application is an original equipment manufacturer (OEM) mobile application that is provided by an OEM of the vehicle.

17. The emergent response communications system of claim 16, wherein the mobile device application is a companion OEM mobile application that is provided by the OEM of the vehicle and that is for providing auxiliary services to authorized individuals including the mobile device user.

18. The emergent response communications system of claim 17, wherein the vehicle mobile application is usable to provide the mobile device user with access to one or more features of the mobile device application including a feature that enables the mobile device user to provide the mobile device user input so as to cause the direct communications between the vehicle user device and the mobile device to be established.

19. An emergent response communications system, comprising:
a primary vehicle management application for engaging with a vehicle, the primary vehicle management application being implemented through primary vehicle management application computer instructions that are executable by one or more processors of a vehicle user device;
a companion mobile application for communicating an indication of an emergent situation to the primary vehicle management application, the companion mobile application being implemented through companion mobile application computer instructions that are executable by one or more processors of a mobile device of a mobile device user; and
a backend application computer system configured to:
receive the indication of the emergent situation from the companion mobile application,
identify a vehicle user based on prestored information that indicates the vehicle user is associated with the mobile device user prior to the indication of the emergent situation being received at the backend application computer system, and
transmit a vehicle-mobile device connect message to the primary vehicle management application used by the vehicle user that is identified based on the mobile device user;
wherein the primary vehicle management application is configured to: in response to receiving the vehicle-mobile device connect message at the primary vehicle management application, establish direct communications between the vehicle user device and the mobile device.

20. The emergent response communications system of claim 19, wherein the primary vehicle management application is an original equipment manufacturer (OEM) mobile application that is provided by an OEM of the vehicle, wherein the mobile device application is a companion OEM mobile application that is provided by the OEM of the vehicle and that is for providing auxiliary services to authorized individuals including the mobile device user.
